(19) United States
(12) Patent Application Publication
(10) Pub. No.: US 2026/0228313 A1
(43) Pub. Date: Aug. 6, 2026

(54) INFORMATION PROCESSING SYSTEM AND INFORMATION PROCESSING METHOD

(71) Applicant: Preferred Networks, Inc., Tokyo (JP)

(72) Inventor: Daisuke OKANOHARA, Tokyo (JP)

(73) Assignee: Preferred Networks, Inc., Tokyo (JP)

(21) Appl. No.: 19/636,710

(22) Filed: Apr. 1, 2026

Related U.S. Application Data
(63) Continuation of application No. PCT/JP2024/035290, filed on Oct. 2, 2024.

(30) Foreign Application Priority Data
Oct. 2, 2023 (JP) 2023-171681

(51) Int. Cl. G06F 21/10; G06F 16/3329

(52) U.S. Cl. CPC G06F 21/1078; G06F 16/33295

(57) ABSTRACT

An information processing system includes one or more processors and one or more memories. The one or more memories store computer-executable instructions configured to, when executed by the one or more processors, cause the one or more processors to acquire a question for which an answer is generated by a first model that is a generative model, retrieve, from a collection of data, based on the question, information to be used by the first model for generating the answer to the question, and grant a royalty to a provider of the information used for the generation of the answer by the first model.

### CROSS REFERENCE TO THE RELATED APPLICATIONS

This application is continuation application of International Application No. JP2024/035290, filed on Oct. 2, 2024, which claims priority to Japanese Application No. 2023-171681, filed on Oct. 2, 2023, the entire contents of which are incorporated herein by reference

### FIELD

The present disclosure relates to an information processing system and an information processing method.

### BACKGROUND

Large language models (LLMs), which are language models using models trained by machine learning, have begun to be utilized in various applications. As one application of large language models, a technique called Retrieval Augmented Generation (RAG) is known, in which information is retrieved in response to an input and the retrieved information is used to generate an output by the large language model.

### BRIEF DESCRIPTION OF DRAWINGS

FIG. 1 is a diagram illustrating an outline of processing according to an embodiment.

FIG. 2 is a diagram illustrating an example of contribution degree calculation processing according to an embodiment.

FIG. 3 is a diagram illustrating pseudocode of an example of contribution degree calculation processing according to an embodiment.

FIGS. 4A and 4B are a diagram illustrating an example of information management according to an embodiment.

FIG. 5 is a diagram illustrating an implementation example of an information processing device constituting at least part of an information processing system according to an embodiment.

### DETAILED DESCRIPTION

According to one embodiment, an information processing system includes one or more processors and one or more memories. The one or more memories store computer-executable instructions configured to, when executed by the one or more processors, cause the one or more processors to acquire a question for which an answer is generated by a first model that is a generative model, retrieve, from a collection of data, based on the question, information to be used by the first model for generating the answer to the question, and grant a royalty to a provider of the information used for the generation of the answer by the first model.

The problems to be solved by embodiments of the present disclosure are not limited to the problems described above, and as examples of some further non-limiting problems, problems corresponding to the effects described in the embodiments may also be defined as problems to be solved in the present disclosure. That is, a problem corresponding to any at least one of the effects described in the description of the embodiments of the present disclosure may be defined as a problem to be solved in the present disclosure.

Embodiments of the present invention will be described below with reference to the drawings. The drawings and description of the embodiments are provided by way of example and do not limit the present invention.

For example, the present disclosure mainly describes a case where text data such as characters and sentences, which are information as a language model, is used. However, embodiments of the present invention are not limited thereto and may also be applied to data such as images, audio, video, sensor data, and the like. By appropriately tokenizing such data, the same can be applied in the embodiments described below.

A large language model that uses retrieval results requires a large amount of data relating to information to be retrieved. Further, this data needs to cover a wide range in the field to be searched, and it is important to what extent the data has been used as a retrieval result, that is, how useful the data was.

To obtain highly useful data, it may be conceivable to assign to a provider of data used for retrieval a degree of contribution according to the usefulness of the data, and to provide an incentive according to the degree of contribution. By setting an appropriate degree of contribution, it becomes possible to improve the overall quality of retrieval data.

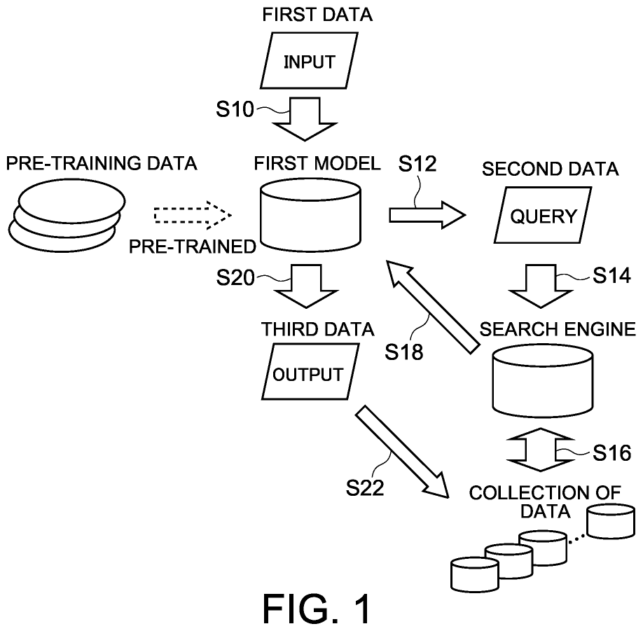

FIG. 1 is a diagram schematically illustrating an outline of processing according to an embodiment. The processing in this figure may be executed, for example, in an information processing system including one or more processors mounted on one or more computers and one or more storage devices (including those provided in the computers). Data transmission/reception and storage locations of data can be arbitrarily set within a range in which no inconsistency arises depending on the system configuration.

In the following, processing is described as processing by at least one processor in the information processing system, even when not explicitly limited to at least one processor, it may indicate that at least one processor executes the processing, or it may indicate the flow of processing as the information processing system as a whole. These can be appropriately reinterpreted within the scope of the technical idea of the present disclosure.

The information processing system is a system that generates and outputs third data, which is output data for first data, which is input data, using a first model, which is a probabilistic model trained using pre-training data. The first model may be, for example, a foundation model or a generative model.

The first data is, for example, text for asking a question to the first model, and is called a prompt. The first data can be reinterpreted as a question for which an answer is generated by the first model depending on the context. In the present disclosure, “question” may conceptually include both a question from a user and an instruction from a user. Also, in the present disclosure, “question” may conceptually include both data input by a user and data obtained by performing predetermined processing on the data.

The first data may include any of images, audio, video, and sensor data as described above. The third data is, for example, text indicating an answer to the question. In the present disclosure, “answer” may conceptually include both an answer to a question and a response to an instruction. Also, in the present disclosure, “answer” may conceptually include both data generated by the first model and data obtained by performing predetermined processing on the generated data. The third data may include any of images, audio, video, and sensor data similarly to the first data. Also, the first data and the third data are not limited to such data and may be data in other formats.

The first model is stored in a storage device in the information processing system and is formed when a processor in the information processing system refers to the storage device. The information processing system executes inference using the first model formed by the processor.

First, the information processing system receives first data as input data (S10). Input of data may be performed to at least one processor in the information processing system via various interfaces. At least one processor in the information processing system may receive, as input data, the first data input by the user, for example.

The first data input by the user is, for example, data that the user inputs or specifies via a user interface of an information terminal, and may be text input via a keyboard, text selected in a sentence, an image dragged and dropped with a mouse, audio collected with a microphone, or the like. Here, the user's information terminal is an example of an information processing device and is one element constituting the information processing system.

At least one processor in the information processing system acquires second data for executing a search necessary for generating third data based on the first data received as input data (S12). The second data is, for example, a query to be input to a search engine. Information searched using the second data is used as additional input for determining output of the third data. That is, the second data is data for searching information relating to an answer to the first data.

At least one processor in the information processing system may, for example, tokenize the first data by inputting the first data into the trained first model, and acquire, as the second data, a query necessary for retrieval based on the acquired tokens. As a non-limiting example, the first model may be a large language model, and in this case, the processor acquires the second data by extracting a search query for generating the third data from tokenized first data for the input first data indicating an input question sentence and the like.

Also, at least one processor in the information processing system may, for example, vectorize the first data and acquire the obtained vector as the second data, which is a query necessary for retrieval. Also, at least one processor in the information processing system may acquire the first data itself as the second data, which is a query necessary for retrieval. Also, at least one processor in the information processing system may use a conventional method to acquire the second data, which is a query to a search engine described later, based on the first data.

At least one processor in the information processing system searches, using the search engine, for information necessary for generating third data using the acquired second data as a query (S14). The search engine is stored in a storage device in the information processing system similarly to the first model, and is formed when at least one processor in the information processing system refers to the storage device. The information processing system executes retrieval of necessary information using the search engine formed by the processor.

The information processing system inputs the second data to the search engine and acquires, from a collection of data, information to be used for generating the third data (S16). Processing by the search engine may be executed by at least one processor in the information processing system. Through this processing, as a non-limiting example, the information processing system can acquire, from the collection of data, information to be used for generating an answer to the first data based on the first data in this processing.

Processing by the search engine can be executed, for example, by using, as keys, data to be searched that is information in the collection of data and extracting keys for the query. Note that the key search by the search engine is not limited to a predetermined method, and a general method for acquiring keys for a query can be used.

Also, the keys and the query may each be encoded. As an example, the search engine can execute retrieval using a function defined from an encoded key and an encoded query. Such key and query encoding can also be learned in advance together at the time of pre-training of the first model.

As a non-limiting example, when the first model is a large language model, at least one processor in the information processing system can generate a query necessary for retrieval from tokenized text, and by referring to keys of the collection of data using this query, can extract information that may include text necessary for an answer to the input text.

Also, the search engine may be an engine formed by any method such as keyword matching, a model formed with an attention mechanism, or a model formed by a learning method using reinforcement learning. However, the search engine is not limited thereto and may be an engine formed by other methods.

At least one processor in the information processing system reflects results searched by the search engine in generation of output data in the first model (S18).

At least one processor in the information processing system generates third data based on the input data received in S10 and information acquired by retrieval for generating the third data, which is output data in the first model (S20). That is, at least one processor in the information processing system can generate an answer to the first data by the first model using this information.

At least one processor in the information processing system may output the generated third data (answer) to the user's information terminal that input the first data in S10. The output third data (answer) may be displayed on the user's information terminal, read aloud as audio on the information terminal, printed via the information terminal, or the like.

As an example, at least one processor in the information processing system can generate, as the third data, a response or answer using this information in addition to knowledge based on pre-training data by inputting the input data and the information acquired by retrieval into the first model. As an example, at least one processor in the information processing system may process the input data and the information acquired by retrieval into a prompt in a predetermined format, input the prompt to the first model, and generate the third data.

As another non-limiting example, at least one processor in the information processing system may incorporate information acquired by retrieval into the first model as input to internal computation of the first model, and input the input data as a prompt to the first model to generate the third data. In this alternative example, an input port for incorporating the information is appropriately designed depending on the architecture of the first model, and may be, for example, any of an input layer, an intermediate layer, and an output layer of the first model.

In the present disclosure, inputting the information acquired by retrieval into the first model or incorporating the information into the first model, and outputting the third data from such a first model, may be referred to as reinforcing the first model with a search result (information acquired by retrieval), or reinforcing output of the first model by retrieval.

The third data is generated, for example, as data obtained by reinforcing output of the first model for the first data by retrieval. Such generated third data can reflect newer information compared with a case where the first model is used alone.

The first model can generate the third data using information of encoded keys set in the collection of data. As a non-limiting example, when the first model is a large language model, the first model can obtain information as retrieval results for the input text as encoded embedding vectors, and reflect the information of the encoded embedding vectors in the output data to generate text or the like with higher accuracy as an answer to a question or the like.

At least one processor in the information processing system calculates and assigns a degree of contribution for information acquired from the collection of data and used for generating the third data (S22). The degree of contribution is an example of an index for evaluating usefulness of information. The degree of contribution may be assigned at the timing when the information is provided to the collection of data. Through this processing, as a non-limiting example, the information processing system can calculate the degree of contribution of the information in generating an answer by the first model.

The above is the overall processing flow of the information processing system including contribution degree calculation processing according to the present disclosure. Next, calculation of the degree of contribution for each piece of information in the collection of data in the information processing system will be described in detail. The information processing system can calculate the degree of contribution of the information at the timing when the information is provided to the collection of data to be searched, or at the timing when the above third data is generated.

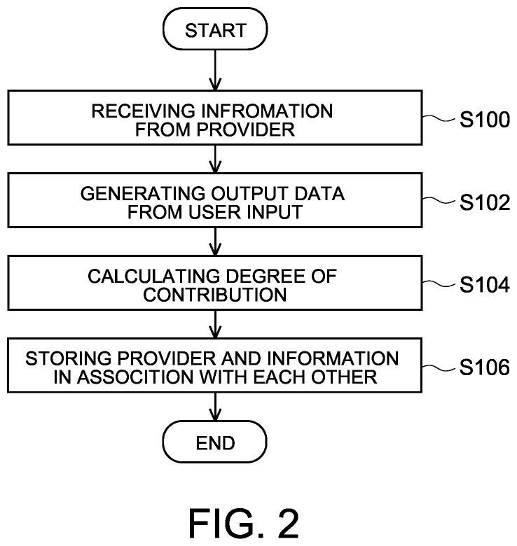

FIG. 2 is a flowchart illustrating an example of first-stage contribution degree calculation processing. As first-stage contribution assignment, the information processing system can set a degree of contribution for the information at the timing when the first data is input and the third data is generated.

However, the information processing system may calculate the first-stage degree of contribution at a timing later than this timing. As another example, the information processing system may calculate the first-stage degree of contribution at the timing when the first model determines to use data retrieved by the search engine for generation of the third data.

The first-stage contribution assignment obtains an evaluation indicating how much influence information provided to the collection of data exerts on the distribution of third data generated by searching the collection of data.

In other words, in a case where third data is generated with retrieval augmentation, the first-stage degree of contribution can be an index of a necessary condition indicating how much influence the provided information can exert on all generated data.

At the timing when the user attempts to obtain the third data using the first model and the search engine, at least one processor in the information processing system can set a degree of contribution for the provided information.

At least one processor in the information processing system receives information provided by a data provider via an appropriate interface (S100). The information may be, for example, news articles, internal documents including personnel information and technical information, health information, image datasets, video datasets, experiment datasets, genome data, confidential information in general, or the like, but is not limited thereto.

Similarly to input/output data, the information provided by the provider is not limited to text and may be information including at least data such as images, audio, video, sensor data, and the like.

The provider of such information may be, for example, a user related to the field of the collection of data, or may be a news publisher in the case of news articles, a company that provided the information or a department thereof in the case of internal documents, and the like.

In accordance with designation by a user who is the provider, the information processing system may accept provision of data by automatically crawling information uploaded to a predetermined database, storage device, or a website existing in a domain. In this case, where the information is provided by another provider through a curation site or the like, the provider of the information may be treated as the original provider of the information referenced by the curation site, and the curation site or the like may be excluded from being treated as the provider.

The provided information may, as one example, be newly stored in a storage area in the information processing system, or, as another example, be newly stored in a storage area outside the information processing system. Further, the information processing system may reference information stored in a storage area outside the information processing system (for example, a location designated by the user).

At least one processor in the information processing system can store the information provided by the provider in an arbitrary location. For example, the information may be stored in a storage area requiring security, and in such a case, this may be implemented by the provider permitting the information processing system to access the information.

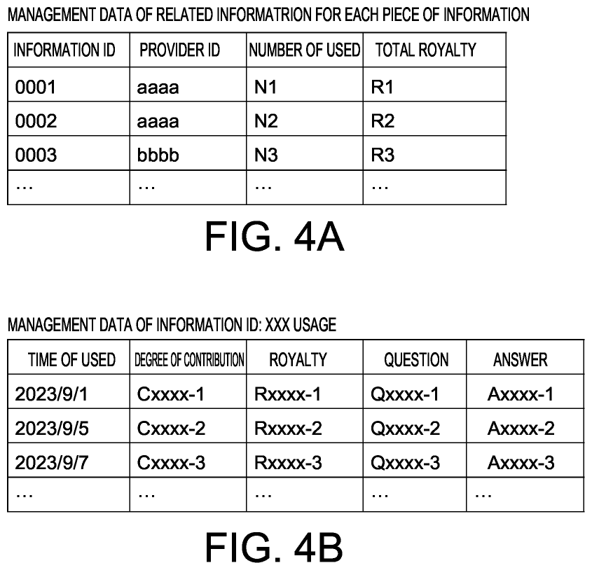

At least one processor in the information processing system may manage the accepted information in association with various pieces of related information, for example, as in management data presented as non-limiting examples as cases in FIG. 4A or FIG. 4B.

For example, as illustrated in FIG. 4A, for each piece of provided information, at least one processor in the information processing system can manage, in association, an information identifier (information ID) for uniquely identifying the information, a provider identifier (provider ID) for uniquely identifying the provider of the information, the number of times the information is used in generating an answer by the first model, and the total amount of royalties to be granted to the provider according to use of the information, by registering these items in one record of a database.

Further, for example, as illustrated in FIG. 4B, at least one processor in the information processing system can manage, in association, a use date and time when the information was used in generating an answer by the first model, a degree of contribution of the information in generating an answer by the first model, an amount of royalties corresponding to the degree of contribution, a question (first data) that triggered use of the information, and an answer (third data) generated by the first model using the information, by registering these items in one record of a database.

At least one processor in the information processing system may acquire all or part of such related information for each piece of information by referring to the management data. Further, in response to a request from the provider of the information or an information processing device of the provider, at least one processor in the information processing system may provide all or part of such related information to the provider of the information or an information processing terminal of the provider.

At least one processor in the information processing system receives first data, which is input data from a user who uses the first model, and generates third data for the first data (S102). At least one processor in the information processing system generates second data from the first data input by the user and executes retrieval based on the second data using the search engine.

At least one processor in the information processing system calculates a degree of contribution in the first stage based on a distribution of third data generated by reflecting retrieval results obtained by executing retrieval using provided information as data to be searched, and a distribution of fourth data generated without executing retrieval (S104). In other words, at least one processor in the information processing system can calculate the degree of contribution using a first model reinforced with retrieval results and a first model not reinforced with retrieval results.

At least one processor in the information processing system can calculate the degree of contribution, for example, by comparing the first model reinforced with retrieval results and the first model not reinforced with retrieval results. Here, the fourth data need not actually be generated.

At least one processor in the information processing system calculates the first-stage degree of contribution using, for example, a distance, or a quantity corresponding to a distance, between the distribution of the third data and the distribution of the fourth data. As a non-limiting example, the information processing system may calculate the degree of contribution using Kullback-Leibler divergence (KL divergence) between the distribution of the third data and the distribution of the fourth data as the quantity corresponding to a distance. Of course, the information processing system can calculate the degree of contribution using other distances or statistics.

$$K L ( P ‖ {P}^{′} ) = \int P ( x ) log \frac{P ( x )}{{P}^{′} ( x )} d x \qquad ( 1 )$$

The KL divergence is represented by Eq. (1). Here, P indicates a distribution of the third data generated by executing retrieval using a collection of data including the provided information, and P′ indicates a distribution of the fourth data generated without executing retrieval. The information processing system can obtain the KL divergence by using data sampled based on probability distributions.

For one prompt (first data), at least one processor in the information processing system executes retrieval using a collection of data after information is provided, and obtains a sample S of the third data in accordance with the probability distribution P. At least one processor in the information processing system repeats this operation multiple times, for example, N times, for the one prompt (first data), thereby obtaining samples S1, S2, . . . , SN in accordance with the distribution P.

At least one processor in the information processing system can obtain the KL divergence as the first-stage degree of contribution indicating how much the provided data contributes, based on, for each sample, the probability P(Si) that the sample occurs in the distribution P of the third data and the probability P′(Si) that the sample occurs in the distribution P′ of the fourth data.

$$K L ( P ‖ {P}^{′} ) ≅ \frac{1}{N} {\sum }_{i = 1}^{N} P ( {S}_{i} ) ( log P ( {S}_{i} ) - log {P}^{′} ( {S}_{i} ) ) \qquad ( 2 )$$

At least one processor in the information processing system calculates the KL divergence by representing sampling results in a discretized form as in Eq. (2). That is, the information processing system may calculate a value approximating the KL divergence. Note that the information processing system may calculate an approximate value of the KL divergence using an equation different from Eq. (2). The sampling may be executed, for example, in accordance with Monte Carlo sampling.

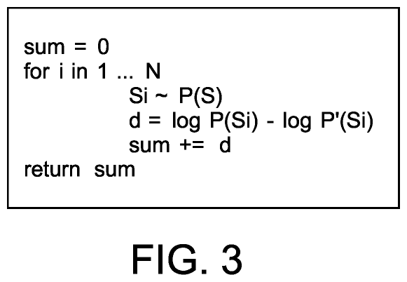

FIG. 3 illustrates an example of pseudocode of KL divergence acquisition processing based on Eq. (2).

At least one processor in the information processing system initializes a variable sum indicating the KL divergence.

At least one processor in the information processing system extracts N samples from the distribution. For example, as described above, the information processing system obtains the N samples by repeating generation of the third data (sample generation) N times for one prompt. Alternatively, as another non-limiting example, instead of generating samples N times, the information processing system may generate sufficiently many items of third data larger than N and randomly extract the N samples from among the generated third data.

For the extracted samples, at least one processor in the information processing system obtains the probabilities P(Si) and P′(Si), which are probabilities that the sample is generated in the distribution P of the third data and the distribution P′ of the fourth data, respectively. The information processing system can calculate the first-stage degree of contribution by calculating, for each of the extracted N samples, a difference d between the logarithms of the respective probabilities, and calculating a sum sum of the differences d over the N samples. Note that the information processing system may normalize the sum by dividing it by N.

Such KL divergence can, for example, serve as an index indicating that output using data not included in pre-training data used in training of the first model can be provided through the first model as output appropriately interpolated by newly provided information. In other words, as the KL divergence becomes larger, it can be said that the provider of the information can appropriately provide data not included in the pre-training data.

Conversely, when a difference between the distribution (distribution shape) of the third data and the distribution (distribution shape) of the fourth data is small and a difference in KL divergence is small, it indicates a high possibility that the provided information is already included in the data used in training. That is, even when retrieval is executed using the provided data, it means that an equivalent answer can be obtained even when the already-trained first model is executed without retrieval processing.

By setting the total number of samples N to a sufficiently large predetermined value, the KL divergence can be obtained as an approximate value of Eq. (2). At least one information processing device in the information processing system may use the discretized KL divergence as the first-stage degree of contribution, or may calculate the first-stage degree of contribution by performing some computation, for example, weighting, on the obtained KL divergence.

For example, as illustrated in FIG. 4, at least one processor in the information processing system may reflect the first-stage degree of contribution on the provider that provided the relevant information, and store the provider (provider ID) and the relevant information (information ID) in association with each other, directly by one record or indirectly by a plurality of records (S106). Further, at least one processor in the information processing system may, for example, increment by one the number of times the information retrieved is used, in management data as illustrated in FIG. 4A. The degree of contribution for the provider may be accumulated, for example, by summing it with degrees of contribution for information provided so far, thereby obtaining a total first-stage degree of contribution for the provider.

Further, at least one processor in the information processing system may apply weighting such that older information is assigned a smaller weight, or may remove information that has elapsed a certain period of time from the scope of the total degree of contribution. By performing processing along a time series in this manner, it is possible to provide information in which newer information is weighted more while taking older information into consideration.

As described above, the information processing system according to the above embodiment can set, when new information to be searched is provided for the collection of data, an appropriate degree of contribution for the newly provided information. Furthermore, the degrees of contribution may be aggregated for each provider. The information processing system can use the first-stage degree of contribution as a necessary condition indicating whether or not the data provided by the data provider can potentially affect the output.

Note that the above description starts from the probability distribution P of the third data; however, the present disclosure is not limited thereto. For example, the information processing system may start from the probability distribution P′ of the fourth data, obtain samples P′(Si′) based on P′, obtain P(Si′) sampled from the probability distribution P of the third data for such Si′, and calculate the degree of contribution using a KL divergence KL(P′∥P).

Further, the provided information that forms the probability distribution P for which the KL divergence becomes high may be used as training data for re-training of the first model. By reflecting such data as training data, it is also possible to improve the accuracy of output data of the first model.

Further, the information processing system may calculate the degree of contribution based on the number of times that processing of FIG. 3 is repeatedly performed and the KL divergence exceeds a predetermined value.

Note that the calculation of the first-stage degree of contribution is not limited to the above examples. Some further examples will be described below; however, the present disclosure is not limited thereto, and any other method may be employed as long as it can appropriately reflect complementarity of information when retrieval is used.

The information processing system can input a prompt (first data) to the first model reinforced with retrieval results to generate data (for example, text), calculate a likelihood that such data would be output from the first model before reinforcement (i.e., the first model without using retrieval results), and calculate the first-stage degree of contribution based on the likelihood. For example, the information processing system can use the reciprocal of the likelihood as the first-stage degree of contribution.

The information processing system can input a prompt (first data) to each of the first model reinforced with retrieval results and the first model not reinforced with retrieval results to generate two items of data, input these two items of data to a model (e.g., a trained model by machine learning) that encodes data into latent variables, and calculate the first-stage degree of contribution based on the respective latent variables. For example, the information processing system can use, as the first-stage degree of contribution, an index such as a Euclidean distance between two latent variables in a latent space, or a value obtained by subtracting a cosine similarity between the two latent variables from 1.

The information processing system can calculate the first-stage degree of contribution based on cross entropy of the distribution P′ of the fourth data with respect to the distribution P of the third data when a prompt (first data) is input. For example, the information processing system may use the cross entropy as the first-stage degree of contribution, or may use a normalized quantity of the cross entropy as the first-stage degree of contribution.

Next, description will be given of processing for calculating, as a second-stage degree of contribution, whether the provided information was useful data for the answer, in addition to the influence of the provided information on the answer. The information processing system may execute calculation of the second-stage degree of contribution at the same timing as calculation of the first-stage degree of contribution described above (i.e., the timing of S104 in FIG. 2), or alternatively, at the timing of actually executing generation of the third data using the first model and the search engine in response to a request from a user (i.e., the timing of S22 in FIG. 1).

At least one processor in the information processing system can calculate the second-stage degree of contribution by evaluating whether the provided data actually contributed usefully to the result. This second-stage evaluation may be realized, for example, using a second model different from the first model. For example, the information processing system can use, as an evaluator, the second model trained as an evaluation model such that, when the input (first data) and the output (third data or fourth data) of the first model are input to the second model, the second model returns a higher evaluation value as the result is more correct (i.e., higher in validity, effectiveness, and/or appropriateness).

For example, when an input to the first model is a user's question and an output of the first model is output as an answer to the question, the second model as an evaluator may evaluate whether the output constitutes an answer to the question, that is, evaluate validity, effectiveness, and/or appropriateness of the output as an answer to the question. At least one of these evaluations may include, as evaluation items, correctness of the content of the output as an answer and/or whether the output maintains an appropriate format (style) as an answer and the degree thereof. In natural language processing, the evaluator may evaluate each evaluation item by performing semantic analysis and contextual analysis.

Further, evaluating validity, effectiveness, and/or appropriateness of a generated answer conceptually includes evaluating the generated answer itself, as well as evaluating it by comparing an output (third data) from the first model reinforced with retrieval results (i.e., reinforced with retrieval results) with an output (fourth data) from the first model not reinforced with retrieval results.

For example, at least one processor in the information processing system can calculate the degree of contribution as an expected value as described below, using the probability distribution P of the third data generated using the provided data as retrieval data and the probability distribution P′ of the fourth data generated without executing retrieval.

$${E}_{P ( S )} [ C ( S ) ] - {E}_{{P}^{′} ( {S}^{′} )} [ C ( {S}^{′} ) ] \qquad ( 3 )$$

Here, C(S) denotes an output value of the evaluator for a sample S, and E(⋅) denotes an expected value. The information processing system calculates the expected value of C for samples S obtained according to the probability distribution P and the expected value of C for samples S′ obtained according to the probability distribution P′. More specifically, for random variables S~P(S) and S′~P′(S′), the expected values of C(S) and C(S′) are calculated using averages over one or more samplings performed multiple times.

As described above, the information processing system can calculate the second-stage degree of contribution by sampling based on the probability distributions P and P′ and calculating expected values of evaluation values. In other words, the information processing system can calculate the degree of contribution using the first model reinforced with retrieval results, the first model not reinforced with retrieval results, and the second model that evaluates an answer generated by the first model. The second model that outputs an evaluation value can be trained by any method. The evaluation value calculated by the second model outputs a higher value as the answer is more correct, as described above.

Therefore, according to Eq. (3), the information processing system can calculate, as the second-stage degree of contribution, a difference between an expected evaluation value for the probability distribution of the third data generated using the provided information for retrieval and an expected evaluation value for the probability distribution of the fourth data generated without executing retrieval.

That is, the second-stage degree of contribution becomes larger as an answer becomes more correct when the provided information is used for retrieval.

As described above, the information processing system according to the above embodiment can calculate a degree of contribution reflecting how much information provided to the collection of data has validity, effectiveness, and/or appropriateness in an answer, and how effective the information is for obtaining a correct answer.

The information processing system can use the first-stage degree of contribution and the second-stage degree of contribution in combination, or may use only one of them. By setting the degrees of contribution as described above, the information processing system can encourage information providers to provide information that improves coverage of information in the first-stage degree of contribution and to provide information that improves validity, effectiveness, and/or appropriateness of data to be answered in the second-stage degree of contribution.

The degree of contribution calculated as described above can be used, as a non-limiting example, as an index for implementing some processing such as payback as royalties to information providers. For example, the information processing system may grant the information provider a royalty (money or a reward equivalent thereto) in an amount corresponding to the degree of contribution of the information. The royalty is a concept that includes an incentive, a reward, a usage fee, points, and the like. Granting a royalty to an information provider may be performed, for example, by associating the royalty amount with an identification code of the information provider, or by another method.

When granting royalties to a provider of information that is retrieved from the collection of data and used for generation of an answer by the first model, the information processing system determines an amount of the royalty in accordance with the degree of contribution of the information. The method of granting royalties is not limited to the above examples.

Alternatively, the information processing system may, for example, grant a uniform amount of royalties to the provider regardless of the magnitude of the degree of contribution, without calculating the degree of contribution of the information retrieved from the collection of data and used for generation of an answer by the first model.

Alternatively, the information processing system may, for example, calculate the degree of contribution of the information retrieved from the collection of data and used for generation of an answer by the first model, and grant a uniform amount of royalties to the provider when the degree of contribution exceeds a predetermined degree of contribution.

That is, the information processing system may be configured to acquire a question (first data) for which an answer is generated by the first model, retrieve, based on the question, information to be used for generating an answer (third data) to the question from the collection of data, and grant royalties to the provider of the information.

The information processing system can be broadly divided into generation of an answer using the first model, a retrieval system using a search engine, and a collection of data used for the search engine. The information processing system may provide any of these as an Application Programming Interface (API).

For example, the information processing system can provide, as a whole, an API relating to input/output of the first model and provide a system for obtaining an answer with retrieval augmentation in which information provided by an information provider is used as a retrieval target.

For example, the information processing system can provide an API relating to input/output of the search engine and provide a system in which information provided by an information provider is used as a retrieval target.

For example, the information processing system can provide an API relating to access to the collection of data and provide, as a system, a route for accessing data used for retrieval by the search engine.

As described above, separation of the system components can be arbitrarily determined. In any of the above API provisions, according to the information processing system of the above embodiment, it is possible to grant an appropriate degree of contribution to data providers.

That is, the information processing system may be in a form including at least one of the first model, the search engine, and a sub-collection of data that is at least a part of the collection of data.

Further, the information processing system may include, as a plurality of different information processing devices, an information processing device that generates the third data and an information processing device that calculates the degree of contribution, or may be in a form in which generation of the third data and calculation of the degree of contribution can be realized in the same information processing device. That is, the information processing system includes one or more information processing devices, and the processing in the present disclosure in these one or more information processing devices can be appropriately distributed or aggregated for execution.

When the information processing system includes the first model, an information processing device that sets a degree of contribution can calculate the degree of contribution based on third data that is output from the first model using data obtained by passing second data output from the first model of the information processing system to a search engine inside or outside the information processing system, and fourth data that is output from the first model without executing retrieval. IDs may be assigned to respective pieces of data (information) in the collection of data, the degree of contribution may be set for each ID (information ID), and pieces of data provided by the same provider may be acquired from the IDs and their degrees of contribution may be aggregated.

When the information processing system includes the search engine, the information processing system that sets a degree of contribution can obtain the third data and the fourth data based on output from the first model inside or outside the information processing system and set the degree of contribution. At the timing of generating the third data, a result obtained using the search engine inside the information processing system can be passed to the first model.

When the information processing system includes at least part of the collection of data, the information processing system that sets a degree of contribution can obtain the third data and the fourth data using the first model and the search engine inside or outside the information processing system at the timing when information is provided, set the degree of contribution, and assign the degree of contribution to each piece of provided information in the collection of data.

The collection of data need not be provided as a whole, and part thereof may be stored confidentially, while an API for accessing an encrypted key may be provided. For example, confidential data in each of a plurality of companies may be stored confidentially in each company, and a route and an interface for accessing such data may be prepared.

In this case, since a sub-collection of data existing in each company can be concealed from the outside, a user who desires an answer using the first model cannot detect which company's data is used for retrieval. On the other hand, the information processing system can identify from which sub-collection of data the information used for generating the answer is acquired, by referring to an ID (information ID) associated with the data in the collection of data.

The information processing system may output information indicating a provider of information (information retrieved and used for generation of an answer by the first model) (for example, provider ID, a character string indicating the provider name, and/or a character string indicating a source or origin of the information such as a URL) in a manner in which a user who has received the answer can identify that the answer has been generated by referring to the information provided by the provider.

Further, the information processing system may output information indicating the provider of the information (information retrieved and used for generation of an answer by the first model) (for example, provider ID, a character string indicating the provider name, and/or a character string indicating a source or origin of the information such as a URL) in a manner in which a user who has received the answer (recipient of the answer) can identify that the answer has been generated by referring to (using) the information provided by the provider (for example, outputting the information together with the answer). The information indicating the provider may be text, an image, or the like.

Further, during actual operation, the information processing system can grant degrees of contribution to information providers that have the above-identified sub-collection of data serving as sources, based on the number of times, frequency, and the like that their information is used for answers.

In any case, the first model can have various forms. As described above, the first model may be, as a large language model, a model that inputs text such as sentences or words and outputs text such as sentences or words. As another example, the first model may be a model that outputs an image or video in response to input of text, a model that outputs text in response to input of an image or video, a model that outputs an image or video in response to input of an image or video, a model that outputs graph information in response to input of graph information, a model that outputs text, an image, or video in response to input of graph information, a model that outputs graph information in response to input of text, an image, or video, and the like. Of course, the first model is not limited to these.

The trained model in the above embodiment may conceptually include, for example, a model that is trained as described above and is further distilled by a general method.

Some or all of each device (such as the information processing device, etc.) in the above embodiment may be configured in hardware, or information processing of software (program) executed by, for example, a CPU (Central Processing Unit), GPU (Graphics Processing Unit). In the case of the information processing of software, software that enables at least some of the functions of each device in the above embodiments may be stored in a non-volatile storage medium (non-volatile computer readable medium) such as CD-ROM (Compact Disc Read Only Memory) or USB (Universal Serial Bus) memory, and the information processing of software may be executed by loading the software into a computer. In addition, the software may also be downloaded through a communication network. Further, entire or a part of the software may be implemented in a circuit such as an ASIC (Application Specific Integrated Circuit) or FPGA (Field Programmable Gate Array), wherein the information processing of the software may be executed by hardware.

A storage medium to store the software may be a removable storage media such as an optical disk, or a fixed type storage medium such as a hard disk, or a memory. The storage medium may be provided inside the computer (a main storage device or an auxiliary storage device) or outside the computer.

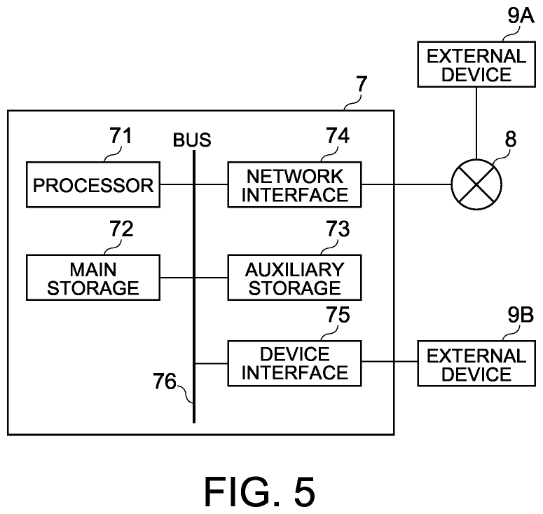

FIG. 5 is a block diagram illustrating an example of a hardware configuration of each device (such as the information processing device, etc.) in the above embodiments. As an example, each device may be implemented as a computer 7 provided with a processor 71, a main storage device 72, an auxiliary storage device 73, a network interface 74, and a device interface 75, which are connected via a bus 76.

The computer 7 of FIG. 5 is provided with each component one by one but may be provided with a plurality of the same components. Although one computer 7 is illustrated in FIG. 5, the software may be installed on a plurality of computers, and each of the plurality of computer may execute the same or a different part of the software processing. In this case, it may be in a form of distributed computing where each of the computers communicates with each of the computers through, for example, the network interface 74 to execute the processing. That is, each device (such as the information processing device, etc.) in the above embodiments may be configured as a system where one or more computers execute the instructions stored in one or more storages to enable functions. Each device may be configured such that the information transmitted from a terminal is processed by one or more computers provided on a cloud and results of the processing are transmitted to the terminal.

Various arithmetic operations of each device (such as the information processing device, etc.) in the above embodiments may be executed in parallel processing using one or more processors or using a plurality of computers over a network. The various arithmetic operations may be allocated to a plurality of arithmetic cores in the processor and executed in parallel processing. Some or all the processes, means, or the like of the present disclosure may be implemented by at least one of the processors or the storage devices provided on a cloud that can communicate with the computer 7 via a network. Thus, each device in the above embodiments may be in a form of parallel computing by one or more computers.

The processor 71 may be an electronic circuit (such as, for example, a processor, processing circuitry, processing circuitry, CPU, GPU, FPGA, or ASIC) that executes at least controlling the computer or arithmetic calculations. The processor 71 may also be, for example, a general-purpose processing circuit, a dedicated processing circuit designed to perform specific operations, or a semiconductor device which includes both the general-purpose processing circuit and the dedicated processing circuit. Further, the processor 71 may also include, for example, an optical circuit or an arithmetic function based on quantum computing.

The processor 71 may execute an arithmetic processing based on data and/or a software input from, for example, each device of the internal configuration of the computer 7, and may output an arithmetic result and a control signal, for example, to each device. The processor 71 may control each component of the computer 7 by executing, for example, an OS (Operating System), or an application of the computer 7.

Each device (such as the information processing device, etc.) in the above embodiments may be enabled by one or more processors 71. The processor 71 may refer to one or more electronic circuits located on one chip, or one or more electronic circuitries arranged on two or more chips or devices. In the case of a plurality of electronic circuitries is used, each electronic circuit may communicate by wired or wireless.

The main storage device 72 may store, for example, instructions to be executed by the processor 71 or various data, and the information stored in the main storage device 72 may be read out by the processor 71. The auxiliary storage device 73 is a storage device other than the main storage device 72. These storage devices shall mean any electronic component capable of storing electronic information and may be a semiconductor memory. The semiconductor memory may be either a volatile or non-volatile memory. The storage device for storing various data or the like in each device (such as the information processing device, etc.) in the above embodiments may be enabled by the main storage device 72 or the auxiliary storage device 73 or may be implemented by a built-in memory built into the processor 71. For example, the storages 102 in the above embodiments may be implemented in the main storage device 72 or the auxiliary storage device 73.

In the case of each device (such as the information processing device, etc.) in the above embodiments is configured by at least one storage device (memory) and at least one processor connected/coupled to/with this at least one storage device, the at least processor may be connected to a single storage device. Or the at least storage may be connected to a single processor. Or each device may include a configuration where at least one of the plurality of processors is connected to at least one of the plurality of storage devices. Further, this configuration may be implemented by a storage device and a processor included in a plurality of computers. Moreover, each device may include a configuration where a storage device is integrated with a processor (for example, a cache memory including an L1 cache or an L2 cache).

The network interface 74 is an interface for connecting to a communication network 8 by wireless or wired. The network interface 74 may be an appropriate interface such as an interface compatible with existing communication standards. With the network interface 74, information may be exchanged with an external device 9A connected via the communication network 8.

Note that the communication network 8 may be, for example, configured as WAN (Wide Area Network), LAN (Local Area Network), or PAN (Personal Area Network), or a combination of thereof, and may be such that information can be exchanged between the computer 7 and the external device 9A. The internet is an example of WAN, IEEE802.11 or Ethernet (registered trademark) is an example of LAN, and Bluetooth (registered trademark) or NFC (Near Field Communication) is an example of PAN.

The device interface 75 is an interface such as, for example, a USB that directly connects to the external device 9B.

The external device 9A is a device connected to the computer 7 via a network. The external device 9B is a device directly connected to the computer 7.

The external device 9A or the external device 9B may be, as an example, an input device. The input device is, for example, a device such as a camera, a microphone, a motion capture, at least one of various sensors, a keyboard, a mouse, or a touch panel, and gives the acquired information to the computer 7. Further, it may be a device including an input unit such as a personal computer, a tablet terminal, or a smartphone, which may have an input unit, a memory, and a processor.

The external device 9A or the external device 9B may be, as an example, an output device. The output device may be, for example, a display device such as, for example, an LCD (Liquid Crystal Display), or an organic EL (Electro Luminescence) panel, or a speaker which outputs audio. Moreover, it may be a device including an output unit such as, for example, a personal computer, a tablet terminal, or a smartphone, which may have an output unit, a memory, and a processor.

Further, the external device 9A or the external device 9B may be a storage device (memory). The external device 9A may be, for example, a network storage device, and the external device 9B may be, for example, an HDD storage.

Furthermore, the external device 9A or the external device 9B may be a device that has at least one function of the configuration element of each device (such as the information processing device, etc.) in the above embodiments. That is, the computer 7 may transmit a part of or all of processing results to the external device 9A or the external device 9B, or receive a part of or all of processing results from the external device 9A or the external device 9B.

In the present specification (including the claims), the representation (including similar expressions) of “at least one of a, b, and c” or “at least one of a, b, or c” includes any combinations of a, b, c, a-b, a-c, b-c, and a-b-c. It also covers combinations with multiple instances of any element such as, for example, a-a, a-b-b, or a-a-b-b-c-c. It further covers, for example, adding another element d beyond a, b, and/or c, such that a-b-c-d.

In the present specification (including the claims), the expressions such as, for example, “data as input,” “using data,” “based on data,” “according to data,” or “in accordance with data” (including similar expressions) are used, unless otherwise specified, this includes cases where data itself is used, or the cases where data is processed in some ways (for example, noise added data, normalized data, feature quantities extracted from the data, or intermediate representation of the data) are used. When it is stated that some results can be obtained “by inputting data,” “by using data,” “based on data,” “according to data,” “in accordance with data” (including similar expressions), unless otherwise specified, this may include cases where the result is obtained based only on the data, and may also include cases where the result is obtained by being affected factors, conditions, and/or states, or the like by other data than the data. When it is stated that “output/outputting data” (including similar expressions), unless otherwise specified, this also includes cases where the data itself is used as output, or the cases where the data is processed in some ways (for example, the data added noise, the data normalized, feature quantity extracted from the data, or intermediate representation of the data) is used as the output.

In the present specification (including the claims), when the terms such as “connected (connection)” and “coupled (coupling)” are used, they are intended as non-limiting terms that include any of “direct connection/coupling,” “indirect connection/coupling,” “electrical connection/coupling,” “communicative connection/coupling,” “operative connection/coupling,” “physical connection/coupling,” or the like. The terms should be interpreted accordingly, depending on the context in which they are used, but any forms of connection/coupling that are not intentionally or naturally excluded should be construed as included in the terms and interpreted in a non-exclusive manner.

In the present specification (including the claims), when the expression such as “A configured to B,” this may include that a physically structure of A has a configuration that can execute operation B, as well as a permanent or a temporary setting/configuration of element A is configured/set to actually execute operation B. For example, when the element A is a general-purpose processor, the processor may have a hardware configuration capable of executing the operation B and may be configured to actually execute the operation B by setting the permanent or the temporary program (instructions). Moreover, when the element A is a dedicated processor, a dedicated arithmetic circuit, or the like, a circuit structure of the processor or the like may be implemented to actually execute the operation B, irrespective of whether or not control instructions and data are actually attached thereto.

In the present specification (including the claims), when a term referring to inclusion or possession (for example, “comprising/including,” “having,” or the like) is used, it is intended as an open-ended term, including the case of inclusion or possession an object other than the object indicated by the object of the term. If the object of these terms implying inclusion or possession is an expression that does not specify a quantity or suggests a singular number (an expression with a or an article), the expression should be construed as not being limited to a specific number.

In the present specification (including the claims), although when the expression such as “one or more,” “at least one,” or the like is used in some places, and the expression that does not specify a quantity or suggests a singular number (the expression with a or an article) is used elsewhere, it is not intended that this expression means “one.” In general, the expression that does not specify a quantity or suggests a singular number (the expression with a or an as article) should be interpreted as not necessarily limited to a specific number.

In the present specification, when it is stated that a particular configuration of an example results in a particular effect (advantage/result), unless there are some other reasons, it should be understood that the effect is also obtained for one or more other embodiments having the configuration. However, it should be understood that the presence or absence of such an effect generally depends on various factors, conditions, and/or states, etc., and that such an effect is not always achieved by the configuration. The effect is merely achieved by the configuration in the embodiments when various factors, conditions, and/or states, etc., are met, but the effect is not always obtained in the claimed invention that defines the configuration or a similar configuration.

In the present specification (including the claims), when the term such as “maximize/maximization” is used, this includes finding a global maximum value, finding an approximate value of the global maximum value, finding a local maximum value, and finding an approximate value of the local maximum value, should be interpreted as appropriate accordingly depending on the context in which the term is used. It also includes finding on the approximated value of these maximum values probabilistically or heuristically. Similarly, when the term such as “minimize/minimization” is used, this includes finding a global minimum value, finding an approximated value of the global minimum value, finding a local minimum value, and finding an approximated value of the local minimum value, and should be interpreted as appropriate accordingly depending on the context in which the term is used. It also includes finding the approximated value of these minimum values probabilistically or heuristically. Similarly, when the term such as “optimize/optimization” is used, this includes finding a global optimum value, finding an approximated value of the global optimum value, finding a local optimum value, and finding an approximated value of the local optimum value, and should be interpreted as appropriate accordingly depending on the context in which the term is used. It also includes finding the approximated value of these optimal values probabilistically or heuristically.

In the present specification (including claims), when a plurality of hardware performs a predetermined process, the respective hardware may cooperate to perform the predetermined process, or some hardware may perform all the predetermined process. Further, a part of the hardware may perform a part of the predetermined process, and the other hardware may perform the rest of the predetermined process. In the present specification (including claims), when an expression (including similar expressions) such as “one or more hardware perform a first process and the one or more hardware perform a second process,” or the like, is used, the hardware that perform the first process and the hardware that perform the second process may be the same hardware, or may be the different hardware. That is: the hardware that perform the first process and the hardware that perform the second process may be included in the one or more hardware. Note that, the hardware may include an electronic circuit, a device including the electronic circuit, or the like.

In the present specification (including the claims), when a plurality of storage devices (memories) store data, an individual storage device among the plurality of storage devices may store only a part of the data or may store the entire data.

Further, some storage devices among the plurality of storage devices may include a configuration for storing data.

An embodiment of the present disclosure is expressed as a non-limiting example, as follows:
(1) An information processing system comprising:
   one or more processors; and
   one or more memories storing computer-executable instructions configured to, when executed by the one or more processors, cause the one or more processors to:
      acquire a question for which an answer is generated by a first model that is a generative model;
         retrieve, from a collection of data, based on the question, information to be used by the first model for generating the answer to the question; and
         grant a royalty to a provider of the information used for the generation of the answer by the first model.
(2) The information processing system according to (1), wherein the computer-executable instructions are configured, when executed by the one or more processors, to cause the one or more processors to manage, regarding the information, at least one of a number of times the information is used, or a total amount of the royalty.
(3) The information processing system according to (1) or (2), wherein the computer-executable instructions are configured, when executed by the one or more processors, to cause the one or more processors to manage, regarding the information, at least one of a date when the information is used for the generation of the answer, a degree of contribution of the information to the generation of the answer, or an amount of the royalty.
(4) The information processing system according to any one of (1) to (3), wherein the computer-executable instructions are configured, when executed by the one or more processors, to cause the one or more processors to manage, regarding the information, at least one of the question that triggers use of the information, or the answer generated by the first model using the information.
(5) The information processing system according to any one of (1) to (4), wherein the computer-executable instructions are configured, when executed by the one or more processors, to cause the one or more processors to provide, regarding the information, to the provider of the information, at least one of a number of times the information is used, an amount of the royalty, a date when the information is used for the generation of the answer, a degree of contribution of the information to the generation of the answer, a question that triggers use of the information, or an answer generated by the first model using the information.
(6) The information processing system according to any one of (1) to (5), wherein the royalty granted to the provider of the information corresponds to a degree of contribution of the information in generation of the answer by the first model.
(7) The information processing system according to (6), wherein the computer-executable instructions are configured, when executed by the one or more processors, to cause the one or more processors to calculate the degree of contribution of the information to the generation of the answer by the first model, using both the first model reinforced with the information and the first model not reinforced with the information.
(8) The information processing system according to (7), the degree of contribution of the information is calculated based on a distribution of data generated using the first model reinforced with the information and a distribution of data generated using the first model not reinforced with the information.
(9) The information processing system according to any one of (1) to (8), wherein the computer-executable instructions are configured, when executed by the one or more processors, to cause the one or more processors to at least calculate a degree of contribution of the information such that the degree of contribution becomes higher when data generated using the first model reinforced with the information has higher validity than data generated using the first model not reinforced with the information.
(10) The information processing system according to any one of (1) to (5), wherein the royalty is a uniform amount.
(11) The information processing system according to any one of (1) to (10), wherein the computer-executable instructions are configured, when executed by the one or more processors, to cause the one or more processors to output provider information indicating the provider of the information used for the generation of the answer by the first model, in a manner that enables a recipient of the answer to identify that the answer has been generated using the information provided by the provider.
(12) The information processing system according to (11), wherein the provider information includes at least one of a provider identifier, a provider name, or URL.
(13) The information processing system according to any one of (1) to (12), wherein the first model is a language model.
(14) The information processing system according to any one of (1) to (13), wherein the computer-executable instructions are configured, when executed by the one or more processors, to cause the one or more processors to generate the answer to the question by the first model based on both the question and the retrieved information.
(15) The information processing system according to any one of (1) to (14), wherein the computer-executable instructions are configured, when executed by the one or more processors, to cause the one or more processors to acquire, based on the question, second data for searching for the information to be used by the first model for generating the answer to the question; and retrieve the information from the collection of data by inputting the second data to a search engine to execute information retrieval.
(16) The information processing system according to (15), wherein the second data is data acquired by inputting the question into a model, and the answer is data generated by inputting, to the first model, both the question and the information retrieved using the search engine based on the second data.
(17) The information processing system according to (16), wherein the model that the question is input into is a same as the first model that the question and the retrieved information is input into.
(18) The information processing system according to any one of (1) to (17), wherein the collection of data includes at least one of a database designated by the provider of the information, a storage device designated by the provider of the information, or a website designated by the provider of the information.
(19) The information processing system according to (18), wherein a curation site providing the information is not the provider that the royalty is granted to.
(20) The information processing system according to any one of (1) to (19), wherein the computer-executable instructions are configured, when executed by the one or more processors, to cause the one or more processors to calculate, for each piece of the information, a degree of contribution to the generation of the answer by the first model.
(21) The information processing system according to any one of (1) to (20), wherein at least a part of the collection of data is confidentially managed by a provider of the part of the collection of data.
(22) The information processing system according to any one of (1) to (21), wherein the information processing system is configured to provide at least one of an application programming interface relating to either or both of input and output of the first model, an application programming interface relating to either or both of input and output of a search engine that retrieves the information from the collection of data, or an application programming interface relating to access to the collection of data.
(23) The information processing system according to any one of (1) to (22), wherein the computer-executable instructions are configured, when executed by the one or more processors, to cause the one or more processors to acquire the question from a user, and provide the generated answer to the user.
(24) The information processing system according to (23), wherein the information used for generating the answer is confidentially managed by the provider to whom the royalty is granted and is accessible to the information processing system based on permission granted by the provider.
(25) The information processing system according to (24), wherein the information used for generating the answer is retrieved via an API from a sub-collection of the collection of data, the sub-collection of the collection of data being confidentially managed by the provider.
(26) The information processing system according to any one of (1) to (25), wherein the computer-executable instructions are further configured, when executed by the one or more processors, to cause the one or more processors to:
   manage management data for the information used for the generation of the answer, the management data including at least one of an information ID, a provider ID, a number of times of use, a total royalty amount, a date and time of use, a degree of contribution, a royalty amount, the question, or the answer; and
   provide at least a part of the management data to the provider of the information.
(27) The information processing system according to any one of (1) to (26), wherein the computer-executable instructions are further configured, when executed by the one or more processors, to cause the one or more processors to:
   manage, for each piece of the information used for the generation of the answer, management data including at least one of an information ID, a provider ID, a number of times of use, a total royalty amount, a date and time of use, a degree of contribution, a royalty amount, the question, or the answer, in association with the piece of information; and
   provide at least a part of the management data for the piece of information to the provider of the piece of information.
(28) The information processing system according to any one of (1) to (27), wherein the collection of data includes multiple pieces of information provided from multiple data sources.
(29) The information processing system according to any one of (1) to (28), wherein the collection of data includes multiple pieces of information provided by multiple providers.
(30) The information processing system according to any one of (1) to (29), wherein the information used for the generation of the answer includes an article provided by a publisher, the publisher being the provider granted the royalty.
(31) The information processing system according to any one of (1) to (30), wherein the collection of data is stored across a plurality of storage areas.
(32) The information processing system according to any one of (1) to (31), wherein the the computer-executable instructions are further configured, when executed by the one or more processors, to cause the one or more processors to identify the provider associated with the information used for the generation of the answer, and grant the royalty to the identified provider.
(33) An information processing system comprising:
   one or more processors; and
      one or more memories storing computer-executable instructions configured to, when executed by the one or more processors, cause the one or more processors to;
         acquire a question for which an answer is generated by a first model that is a generative model;
         retrieve, from a collection of data, based on the question, one or more pieces of information to be used by the first model for generating the answer to the question;
         generate, by the first model using the one or more pieces of information, the answer to the question;
         manage, for each piece of information used for the generation of the answer, management data including at least one of an information ID, a provider ID, a number of times of use, a total royalty amount, a date and time of use, a degree of contribution, a royalty amount, the question, or the answer, in association with the piece of information; and
   provide at least a part of the management data for the piece of information to the provider of the piece of information.
(34) An information processing method comprising:
   acquiring, by one or more processors, a question for which an answer is generated by a first model that is a generative model;
   retrieving, by the one or more processors, from a collection of data, based on the question, information to be used by the first model for generating the answer to the question;
   generating, by the one or more processors, the answer to the question by the first model using the information; and
   granting, by the one or more processors, a royalty to a provider of the information used for the generation of the answer by the first model.

While certain embodiments of the present disclosure have been described in detail above, the present disclosure is not limited to the individual embodiments described above. Various additions, changes, substitutions, partial deletions, etc. are possible to the extent that they do not deviate from the conceptual idea and purpose of the present disclosure derived from the contents specified in the claims and their equivalents. For example, when numerical values or mathematical formulas are used in the description in the above-described embodiments, they are shown for illustrative purposes only and do not limit the scope of the present disclosure. Further, the order of each operation shown in the embodiments is also an example, and does not limit the scope of the present disclosure.

1. An information processing system comprising:
one or more processors; and
one or more memories storing computer-executable instructions configured to, when executed by the one or more processors, cause the one or more processors to:
acquire a question for which an answer is generated by a first model that is a generative model;
retrieve, from a collection of data, based on the question, information to be used by the first model for generating the answer to the question; and
grant a royalty to a provider of the information used for the generation of the answer by the first model.

2. The information processing system according to claim 1, wherein the computer-executable instructions are configured, when executed by the one or more processors, to cause the one or more processors to manage, regarding the information, at least one of a number of times the information is used, or a total amount of the royalty.

3. The information processing system according to claim 1, wherein the computer-executable instructions are configured, when executed by the one or more processors, to cause the one or more processors to manage, regarding the information, at least one of a date when the information is used for the generation of the answer, a degree of contribution of the information to the generation of the answer, or an amount of the royalty.

4. The information processing system according to claim 1, wherein the computer-executable instructions are configured, when executed by the one or more processors, to cause the one or more processors to manage, regarding the information, at least one of the question that triggers use of the information, or the answer generated by the first model using the information.

5. The information processing system according to claim 1, wherein the computer-executable instructions are configured, when executed by the one or more processors, to cause the one or more processors to provide, regarding the information, to the provider of the information, at least one of a number of times the information is used, an amount of the royalty, a date when the information is used for the generation of the answer, a degree of contribution of the information to the generation of the answer, a question that triggers use of the information, or an answer generated by the first model using the information.

6. The information processing system according to claim 1, wherein the royalty granted to the provider of the information corresponds to a degree of contribution of the information in generation of the answer by the first model.

7. The information processing system according to claim 6, wherein the computer-executable instructions are configured, when executed by the one or more processors, to cause the one or more processors to calculate the degree of contribution of the information to the generation of the answer by the first model, using both the first model reinforced with the information and the first model not reinforced with the information.

8. The information processing system according to claim 7, the degree of contribution of the information is calculated based on a distribution of data generated using the first model reinforced with the information and a distribution of data generated using the first model not reinforced with the information.

9. The information processing system according to claim 1, wherein the computer-executable instructions are configured, when executed by the one or more processors, to cause the one or more processors to at least calculate a degree of contribution of the information such that the degree of contribution becomes higher when data generated using the first model reinforced with the information has higher validity than data generated using the first model not reinforced with the information.

10. The information processing system according to claim 1, wherein the royalty is a uniform amount.

11. The information processing system according to claim 1, wherein the computer-executable instructions are configured, when executed by the one or more processors, to cause the one or more processors to output provider information indicating the provider of the information used for the generation of the answer by the first model, in a manner that enables a recipient of the answer to identify that the answer has been generated using the information provided by the provider.

12. The information processing system according to claim 11, wherein the provider information includes at least one of a provider identifier, a provider name, or URL.

13. The information processing system according to claim 1, wherein the first model is a language model.

14. The information processing system according to claim 1, wherein the computer-executable instructions are configured, when executed by the one or more processors, to cause the one or more processors to generate the answer to the question by the first model based on both the question and the retrieved information.

15. The information processing system according to claim 1, wherein the computer-executable instructions are configured, when executed by the one or more processors, to cause the one or more processors to:
acquire, based on the question, second data for searching for the information to be used by the first model for generating the answer to the question; and
retrieve the information from the collection of data by inputting the second data to a search engine to execute information retrieval.

16. The information processing system according to claim 15, wherein the second data is data acquired by inputting the question into a model, and the answer is data generated by inputting, to the first model, both the question and the information retrieved using the search engine based on the second data.

17. The information processing system according to claim 16, wherein the model that the question is input into is a same as the first model that the question and the retrieved information is input into.

18. The information processing system according to claim 1, wherein the collection of data includes at least one of a database designated by the provider of the information, a storage device designated by the provider of the information, or a website designated by the provider of the information.

19. The information processing system according to claim 18, wherein a curation site providing the information is not the provider that the royalty is granted to.

20. The information processing system according to claim 1, wherein the computer-executable instructions are configured, when executed by the one or more processors, to cause the one or more processors to calculate, for each piece of the information, a degree of contribution to the generation of the answer by the first model.

21. The information processing system according to claim 1, wherein at least a part of the collection of data is confidentially managed by a provider of the part of the collection of data.

22. The information processing system according to claim 1, wherein the information processing system is configured to provide at least one of an application programming interface relating to either or both of input and output of the first model, an application programming interface relating to either or both of input and output of a search engine that retrieves the information from the collection of data, or an application programming interface relating to access to the collection of data.

23. The information processing system according to claim 1, wherein the computer-executable instructions are configured, when executed by the one or more processors, to cause the one or more processors to acquire the question from a user, and provide the generated answer to the user.

24. The information processing system according to claim 23, wherein the information used for generating the answer is confidentially managed by the provider to whom the royalty is granted and is accessible to the information processing system based on permission granted by the provider.

25. The information processing system according to claim 24, wherein the information used for generating the answer is retrieved via an API from a sub-collection of the collection of data, the sub-collection of the collection of data being confidentially managed by the provider.

26. The information processing system according to claim 1, wherein the computer-executable instructions are further configured, when executed by the one or more processors, to cause the one or more processors to:
manage management data for the information used for the generation of the answer, the management data including at least one of an information ID, a provider ID, a number of times of use, a total royalty amount, a date and time of use, a degree of contribution, a royalty amount, the question, or the answer; and
provide at least a part of the management data to the provider of the information.

27. The information processing system according to claim 1, wherein the computer-executable instructions are further configured, when executed by the one or more processors, to cause the one or more processors to:
manage, for each piece of the information used for the generation of the answer, management data including at least one of an information ID, a provider ID, a number of times of use, a total royalty amount, a date and time of use, a degree of contribution, a royalty amount, the question, or the answer, in association with the piece of information; and
provide at least a part of the management data for the piece of information to the provider of the piece of information.

28. The information processing system according to claim 1, wherein the collection of data includes multiple pieces of information provided from multiple data sources.

29. The information processing system according to claim 1, wherein the collection of data includes multiple pieces of information provided by multiple providers.

30. The information processing system according to claim 1, wherein the information used for the generation of the answer includes an article provided by a publisher, the publisher being the provider granted the royalty.

31. The information processing system according to claim 1, wherein the collection of data is stored across a plurality of storage areas.

32. The information processing system according to claim 1, wherein the computer-executable instructions are further configured, when executed by the one or more processors, to cause the one or more processors to identify the provider associated with the information used for the generation of the answer, and grant the royalty to the identified provider.

33. An information processing system comprising:
one or more processors; and
one or more memories storing computer-executable instructions configured to, when executed by the one or more processors, cause the one or more processors to;
acquire a question for which an answer is generated by a first model that is a generative model;
retrieve, from a collection of data, based on the question, one or more pieces of information to be used by the first model for generating the answer to the question;
generate, by the first model using the one or more pieces of information, the answer to the question;
manage, for each piece of information used for the generation of the answer, management data including at least one of an information ID, a provider ID, a number of times of use, a total royalty amount, a date and time of use, a degree of contribution, a royalty amount, the question, or the answer, in association with the piece of information; and
provide at least a part of the management data for the piece of information to the provider of the piece of information.

34. An information processing method comprising:
acquiring, by one or more processors, a question for which an answer is generated by a first model that is a generative model;
retrieving, by the one or more processors, from a collection of data, based on the question, information to be used by the first model for generating the answer to the question;
generating, by the one or more processors, the answer to the question by the first model using the information; and
granting, by the one or more processors, a royalty to a provider of the information used for the generation of the answer by the first model.
